(19) United States
(12) Patent Application Publication
(10) Pub. No.: US 2022/0388201 A1
(43) Pub. Date: Dec. 8, 2022

(54) METHOD FOR PRODUCING MOULDED PARTS FROM FIBROUS MATERIAL

(71) Applicant: Kiefel GmbH, Freilassing (DE)

(72) Inventors: Peter Knoll, Ainring (DE); Sebastian Wohlmayer, Ainring (DE)

(21) Appl. No.: 17/805,709

(22) Filed: Jun. 7, 2022

(30) Foreign Application Priority Data
Jun. 8, 2021 (DE) 102021114662.3

(51) Int. Cl. B29B 11/12; B29B 11/16

(52) U.S. Cl. CPC B29B 11/12; B29B 11/16

(57) ABSTRACT

The present disclosure relates to a first molding station (1) for the partial-moulding (210) and pre-molding (220) of molded parts (10) made of fibrous material, a fiber molding system (100) with such a first molding station (1) and a method (200) for operating this first molding station (1) or the fiber moulding system (100), and a molded part (10) produced using such a method.

### TECHNICAL FIELD

Embodiments described herein relate to a first molding station for the partial-molding and pre-molding of molded parts out of fibrous material, a fiber molding system with such a first molding station and a method for operating this first molding station or the fiber molding system, and a molded part produced using such a method.

### BACKGROUND

It is desirable to protect citizens and the environment from plastic pollution. In particular, single-use plastic products such as packaging materials or plastic cutlery and tableware generate a large amount of waste. In this respect, there is an increasing need for substitutes for packaging materials and containers made of plastic, with which these products can be made from recyclable plastics, materials with less plastic content or even from plastic-free materials.

The idea of using natural fibers instead of conventional plastics in the extrusion process has existed at least since the early 1990s, see for example EP 0 447 792 B1. As in most fiber-processing processes, the basic raw material is pulp. In principle, pulp consists of water, natural fibers and a binder, such as industrial starch (potato starch) and has a paste-like consistency.

Since consumers are interested in a very wide variety of ecologically friendly products with different sizes, shapes, and requirements, and do not necessarily ask for them in very large quantities, it would be desirable to have available a process for producing environmentally friendly molded parts made of natural fibers and a corresponding machine, in order to be able to reproducibly produce these products (molded parts) effectively, flexibly and with a good level of quality. Moreover, it is very important here if the molded parts can be produced in large numbers in the shortest possible time, with the result that systems or stations with a large throughput are desirable.

### SUMMARY

An object of the present disclosure is to provide a fiber molding station or fiber molding systems for blanks made of fibrous material and a corresponding production method, with which these products (blanks) are to be reproducibly produced effectively, flexibly, with a good level of quality and as large a throughput as possible.

According to a first aspect of the present disclosure, the object is achieved by a first molding station for a fiber molding system for the partial-molding and pre-molding of a molded part out of fibrous material, possibly environmentally degradable fibrous material, in a fiber molding process comprising:
a reservoir having a pulp as liquid solution comprising the fibrous material for the molded part to be partial-molded;
a first and second suction tool as partial-molding station with, in each case, a plurality of suction heads for drawing the fibrous material for the partial-molding of the molded part out of the reservoir having the pulp;
a pre-pressing station with a pre-pressing tool having a contour that is or can be adapted to the first and second suction tool for the pre-molding of the partial-molded molded parts located in the first or second suction tools, wherein the molded parts are pressed onto the pre-pressing tool with a pre-pressing pressure in order to reduce a moisture content in the molded part and to bring about a shape stabilization of the molded part; and
a transport device comprising a carrier with the first suction tool arranged on a first side of the carrier and the second suction tool arranged on the opposite, second side of the carrier, wherein the respective suction heads are arranged on a side of the suction tools facing away from the carrier in each case, wherein by means of the transport device, possibly independently of each other, the carrier can be rotated and moved along a route at least from a first position for receiving fibrous material from the reservoir of pulp by means of one of the suction tools to a second position for exerting the pre-pressing pressure on the molded parts located in the suction tool.

The term “fibrous material” denotes fibrous materials of all types suitable for molding blanks, wherein these may possibly also be broken down under environmental influences such as humidity, temperature and/or light. The breakdown process is effected over time, optionally also quickly, thus for example in the range of days, weeks or a few months. Possibly, no environmental hazard or contamination arises from either the fibrous material or the decomposition products. Within the meaning of the present disclosure, fibrous materials are for example synthetic fibers or natural fibers obtained from cellulose, paper, cardboard, wood, grass, plant fibers, sugarcane residues, hemp etc. or from their constituents or parts thereof and/or correspondingly recycled material. However, an environmentally degradable fibrous material can also denote synthetically produced fibers such as for example PLAs (polylactides) etc., which correspond to the above fibrous materials or have the properties thereof. The fibrous material is possibly compostable. The fibrous material, and the containers produced therefrom, is possibly suitable for introduction into the recovered substance cycle of German bio-bins and as a resource for biogas plants. The fibrous materials and the containers produced therefrom are possibly biologically degradable in accordance with EU standard EN 13432.

The term “pulp” denotes liquid matter which contains fibers, the fibrous material here. The term “liquid” denotes here the aggregate state of the pulp, wherein the liquid pulp comprises the fibrous material in the form of fibers (liquid solution with the fibrous material). Here, the fibers can be present as individual fibers, as a fiber structure or a fiber group composed of several connected fibers. The fibers represent the fibrous material irrespective of whether they are present in the pulp as individual fibers, as a fiber structure or a fiber group. Here, the fibers are dissolved in the liquid solution such that they float in the liquid solution with, as far as possible, the same concentration irrespective of location, for example as a mixture or suspension of liquid solution and fibrous material. For this, in some embodiments the pulp can, for example, be correspondingly heat-treated and/or circulated. The pulp possibly has a low stock consistency, i.e. a proportion of fibrous material of less than 8%. In an embodiment, a pulp with a proportion of fibrous material of less than 5%, possibly of less than 2%, particularly possibly of between 0.5% and 1.0%, is used in the method according to the disclosed embodiments. The above percentages are to be understood as percent by weight. This low proportion of fibrous material can, among other things, prevent a clumping of the fibrous material in the liquid solution, with the result that the fibrous material can still be partial-molded on the suction tool with a good level of quality. Although clumped fibrous material can be drawn through the suction tool, it would probably result in a molded part with fluctuating layer thickness, which is to be avoided in the production of the molded parts as far as possible. In this respect, the proportion of fibrous material in the pulp should possibly be small enough that clumping or linking to one another does not occur or does so only to a negligible degree. The liquid solution can be any solution suitable for the fiber molding process. For example, the pulp can be an aqueous solution with the fibrous material. Among other things, an aqueous solution represents a solution that is easy to handle.

The fiber molding process denotes the process steps which are involved in molding the molded part, starting with the provision of the pulp, the partial-molding of the molded part in the partial-molding station of the first molding station out of the fibrous material made of the pulp, the pre-molding of the molded part in the pre-molding station of the first molding station, the hot pressing of the molded part in the hot-pressing station of the second molding station and possibly the coating of the molded part with functional layers, wherein the coating can be arranged, in the fiber molding process, at every point suitable for this for the respective layer to be applied.

The molded parts can have any desired shape, also called contour here, if this shape (or contour) can be produced in the method according to the disclosed embodiments or if the method is suitable for the production of this shape (or contour). Here, the components used for the fiber molding process can be adapted to the respective shape (or contour) of the molded part. In the case of different molded parts with different shapes (or contours), different correspondingly adapted components, such as for example the suction tool, the suction head, the pre-pressing station, the hot-pressing station, etc., can be used. Possibly, the target contour of the molded part, and thus the corresponding molding components, is designed such that all surfaces of the molded part have an angle α of at least 3 degrees relative to the pressing direction during the hot pressing. Finish-molded parts can represent a very wide variety of products, for example cups, containers, pots, lids, bowls, portion pots, wraps or surrounding containers for a very wide variety of purposes.

The suction tool denotes here the tool in which the suction head or heads for the partial-molding of the molded part are arranged. Here, several suction heads are arranged in the common suction tool, with the result that the individual suction heads in the suction tool are moved along equally with the movement of the suction tool. The supply of media to the suction tool with several suction heads is guided suitably to the individual suction heads through the carrier in the suction tool.

Positioning the suction tool on the pulp denotes touching the pulp with all suction heads located in the suction tool which are provided for the partial-molding of molded parts, in such a manner that, because of the negative pressure or suction pressure applied to the pulp with the suction tool, the fibrous material is drawn out of the pulp or the pulp is drawn in with fibrous material dissolved therein. In the case of partial immersion into the pulp, the suction tool is not only positioned on the pulp, but is plunged into it. The depth of immersion of the suction tool into the pulp depends on the respective application and the respective fiber molding process and can differ according to the application and possibly the molded part to be partial-molded.

The suction heads comprise in each case a three-dimensionally shaped suction head suction side, the shape of which is adapted to a contour of the later molded part, and the molded part is partial-molded on the suction head suction side by means of negative pressure in the suction tool. Here, the suction head can have a negative mold. A negative mold denotes a mold where the suction side of the suction head, thus the side where the fibrous material accumulates because of the suction effect of the suction head and thus partial-molds the molded part, is located on the inside of the suction head, with the result that this inside forms a cavity, into which the pulp with the fibrous material is drawn, after the suction head has been positioned on the pulp or after the suction head has been immersed in the pulp. In the case of a negative mold, the outside of the later molded part is directed towards the inside of the suction head. After the partial-molding, therefore, the molded part sits internally on the inside of the suction head. Here, the suction head can also have a positive mold. A positive mold denotes a mold where the suction side of the suction head, thus the side where the fibrous material accumulates because of the suction effect of the suction head and thus partial-molds the molded part, is located on the outside of the suction head, with the result that this outside does not form a cavity after the suction head has been positioned on the pulp or after the suction head has been immersed in the pulp. In the case of a positive mold, the inside of the later molded part is directed towards the outside of the suction head. After the partial-molding, therefore, the molded part sits on the outside of the suction head.

The partial-molding of the molded part denotes a first pre-molding of the molded part, wherein this is formed of fibrous material, formerly randomly distributed in the pulp, by means of accumulation of the fibrous material on the contour of the suction head with the corresponding contour. The partial-molded molded part still has a large proportion, for example 70%-80% (percent by weight), of liquid solution, for example water, and is therefore not yet firmly dimensionally stable.

By the partial-molding station, a molded part is partial-molded in a simple manner out of a pulp with a fibrous material, which can provide molded parts with a very wide variety of contours very flexibly depending on the design of the contour of the suction head. Here, the ratio of width or diameter to height of the molded part does not represent a limiting or critical parameter for the quality of the production of the respective molded parts. The partial-molding station according to the disclosed embodiments makes it possible to produce the molded parts very reproducibly and with high precision and quality with respect to the shape and layer thickness of the individual molded part sections. The partial-molding station is capable of processing fibers of a very wide variety of types, if these can be brought into solution such that a greater clumping of the fibers in the liquid solution prior to the processing can be prevented. In particular, robust molded parts can in this way be produced easily, effectively and flexibly from environmentally degradable fibrous material with a good level of quality and with good reproducibility.

In a further embodiment, the suction head suction side of the suction head is formed of a porous screen on a suction-side surface of the suction head. In a further embodiment, the suction tool comprises a plurality of suction channels which end on the suction-side surface underneath the screen and are distributed over the suction-side surface such that a substantially equal suction power is made possible in all regions between the screen and the suction-side surface. In a further embodiment, the molds of the suction heads in the suction tool can differ at least in part, possibly identical molds of the suction heads are arranged adjacent in the suction tool. The different molds can be arranged for example modularly in the suction tool. Such a suction tool is capable of producing different molded parts simultaneously in the same fiber molding process. For example, vessels such as cups and associated lids can thus be partial-molded and processed further simultaneously in the same suction tool.

By the pre-molding station, a pre-molded molded part that is sufficiently robust for the further treatment and has a further reduced proportion of liquid solution is produced in a simple manner from a still mechanically unstable molded part by means of pre-pressing. The pre-molding station makes it possible to produce and further process the molded parts very reproducibly and with high precision and quality with respect to the shape and layer thickness of the individual molded part sections. In an embodiment, the pre-pressing can be carried out at a temperature of the pre-pressing station lower than 80° C., possibly lower than 50° C., particularly possibly at room temperature. Through the pre-pressing, the liquid content in the molded part is reduced to approx. 55%-65% (percent by weight) and the molded part is pre-solidified such that it is sufficiently dimensionally stable for a transfer between tools. A temperature that is too high would lower the liquid content in the molded part too much, as a result of which the material could already be too stiff for the subsequent hot pressing. Precisely the combination of pre-pressing and hot pressing improves the reproducibility during the production of molded parts with a good level of quality and with a small amount of waste. In a further embodiment, the pre-pressing is carried out at a pre-pressing pressure of between 0.2 N/mm2 and 0.3 N/mm2, possibly of between 0.23 N/mm2 and 0.27 N/mm2. These moderate pressures, which are lower than the hot-pressing pressure, make it possible to solidify the molded part gently while reducing the liquid moderately, which is advantageous for a low-waste hot-pressing process. Here, the pre-pressing station comprises a pre-pressing tool, the shape of which is adapted to the partial-molded molded part remaining in the suction tool such that it can be attached to the pre-pressing tool such that it is arranged between the pre-pressing tool and the suction tool in order that the suction tool can be pressed onto the pre-pressing tool with the pre-pressing pressure. Here, the suction tool can be pressed onto a stationary pre-pressing tool or the pre-pressing tool is pressed onto a suction tool stationary in the second position. In an embodiment, the suction tool is positioned on the pre-pressing tool in the second position and pressed onto the pre-pressing tool by means of the transport device via the carrier. Alternatively, the suction tool can also be fastened on a robot arm, which itself exerts the pre-pressing pressure on the pre-pressing tool via the suction tool. Alternatively, the pre-pressing can be performed as a membrane pressing, wherein the pre-pressing tool is implemented as a flexible membrane and the pre-pressing pressure is applied to the membrane, which is then pressed onto the outer contour of the molded part, as a gas pressure. Membrane pressing is particularly suitable for geometries of the molded part where pressure is to be exerted on a large surface area. With a membrane pressing, surface areas which are perpendicular to each other in any spatial alignment can also be put under the same pressure simultaneously, as the pre-pressing pressure is generated during the membrane pressing by means of gas pressure, for example by means of compressed air, which acts on the membrane independently of the direction. Pre-pressing tools made of an elastomer or at least partially of elastomer are also advantageous, as the elastomer can still be deformed slightly under pressure and thus flexibly adapts to a suction tool possibly bending under the pre-pressing pressure and thus improves the homogeneity of the molding of the various molded parts in the suction tool. For elevated pre-pressing temperatures below 100° C., for example, silicone as elastomer is likewise very suitable as a temperature-resistant material in this range.

The carrier has a first side and a second side, lying opposite this side, on which in each case a suction tool with in each case a plurality of suction heads for the partial-molding of a plurality of blanks is arranged. The fastening of the suction tools on the carrier can be implemented fixedly or reversibly. In the latter case, an automatic change of the suction heads is made possible. The respective suction heads are arranged on the side of the suction tools facing away from the carrier in each case, in order that the suction heads are freely accessible for the partial-molding and pre-pressing of the blanks. Because suction tools are arranged on both sides of the carrier, one suction tool can be used for the partial-molding and the other suction tool can be used for the pre-pressing. As the partial-molding and the pre-pressing take up a certain amount of process time, the blanks can be either taken out of the other suction tool or further processed during this process. Through this, the throughput is significantly increased with a single first molding station compared with a purely sequential processing of partial-molding, pre-pressing and transfer of the blanks to a transfer unit in the case of only one suction tool. As a result, the throughput of a corresponding fiber molding system can be significantly increased with the first molding station according to the disclosed embodiments.

In order that this process acceleration can be achieved, the transport device is provided to rotate and move the carrier and thus the suction heads arranged thereon as partial-molding station between a first position for receiving fibrous material from the reservoir of pulp by means of one of the suction tools and a second position for exerting the pre-pressing pressure on the molded parts located in the suction tool. The section between the first and the second position is called the route, which, depending on the design of the first molding station, be a linear route or a route designed differently depending on the requirement. The transport device can be designed differently depending on the requirement and weight of the suction tools as well as the pre-pressing pressure to be applied. For example, the carrier can be suspended from a rail frame and moved along the rail tracks by means of a motor, cable pull, chain or other suitable means. For a rotation of the carrier, the latter can, for example, be rotatably mounted via a shaft in corresponding bearings. Here, the bearings of the carrier would be moved along the route. The rotation of the carrier can be implemented with a corresponding rotary motor, wherein the rotation can be transferred to the carrier by the motor directly or by means of chains, gear rims, etc. A person skilled in the art is capable of providing such mechanisms for moving a component along a route and for rotating it.

The first molding station according to the disclosed embodiments is thus capable of providing blanks made of fibrous material, in which these are to be reproducibly produced effectively, flexibly, with a good level of quality and with as high a throughput as possible.

In an embodiment, for this, the transport device is provided to drive the carrier into the first position after pre-pressing with one of the suction tools has been carried out in the second position, without rotation of the carrier, that now molded parts can be partial-molded out of the reservoir having pulp in the suction tool facing away from the pre-pressing tool during the pre-pressing that has been carried out. Both suction tools are thus occupied by blanks, with the result that the already pre-pressed blanks can subsequently be taken out of the other suction tool in a time-saving manner during the transfer of the partial-molded blanks.

In a further embodiment, for this, the transport device is provided to rotate the carrier, after pre-pressing of the molded parts with one of the suction tools has been carried out and after partial-molding of the molded parts in the other of the suction tools has been carried out, to a suitable position between the first and the second position and to transfer the pre-pressed molded parts to a transfer unit of the transport device, in order to remove them from the route of the carrier for forwarding to subsequent processes.

In a further embodiment, the transport device is provided to eject the pre-pressed blanks from the suction tool by means of a pressure surge, and thus to transfer them to the transfer unit. In principle, the blanks are held in the suction tool because of the negative pressure in the suction heads. When the negative pressure in a suction tool pointing downwards is switched off, the blanks would have to detach from this suction tool because of gravity. As the blanks may possibly sit too firmly in the suction heads for this due to the pre-pressing process, a pressure surge from the suction tool can detach the blanks safely from the suction heads, with the result that the transfer to the transfer unit is achieved problem-free and reliably for all blanks of the suction tool.

Here, the transfer unit can comprise a plurality contour adapted to the shape and number of blanks on the side facing the suction tool for the transfer of the blanks to this contour. Due to the secure seat of the blanks on the contour of the transfer unit, a secure and reliable transfer of the blanks to the second molding station can be achieved.

In a further embodiment, the first molding station furthermore comprises a spraying unit, which is provided at least to spray the suction tool having the partial-molded blanks with a liquid before the pre-pressing during the route of the carrier to the second position. This spraying serves to clean the suction tool of fibrous material at points outside the blanks. Although the spraying can also be carried out after the pre-pressing, the contaminations could adhere to the suction tool too strongly because of the pre-pressing pressure. The spraying, and thus cleaning, before the pre-pressing is therefore advantageous.

In a further embodiment, the spraying unit is furthermore designed and provided to provide the blanks with a functional coating after the pre-pressing on the route of the carrier in the direction of the first position, possibly likewise by means of spraying. Functional layers could be, for example, wax layers for a moisture resistance of the blanks. Other materials for other purposes can also be applied.

In an embodiment, the first and the second suction tool is connected to a gas-line system via the carrier such that a negative pressure generated in the gas-line system by means of one or more vacuum pumps is made available as suction pressure at the respective suction heads for drawing in the fibrous material. The vacuum pump can be positioned at a location removed from the suction tool and distribute the negative pressure generated to the suction heads via the gas-line system. In a further embodiment, the gas-line system also comprises compressed-gas lines for applying compressed air to the suction heads. Through a compressed-air surge the molded parts can be ejected from the suction tool, such as for example for a transfer to subsequent processes, such as the transfer to the transfer unit.

In a further embodiment, the transport device is provided by a robot arm, freely movable in space, with installed carrier. The carrier or the partial-molding station can thereby be transferred easily and flexibly to the pre-molding stations and optionally also as a transfer unit to the second molding station. Thus, the production process can, among other things, be further accelerated or modified depending on the production rate required.

In a further embodiment, the first molding station comprises a changing system for the automatic replacement of the suction tools and the pre-pressing tool, wherein a tool carrier movable out of the first molding station is provided in the changing system for transporting the replaced tools away from the first molding station and the tool carrier can pass through a reversed sequence for the insertion of new tools. Outside the first molding station, the tool carrier can then be unloaded and equipped with other tools for example by means of a robot or manually. If tools are mentioned in this connection, the suction tools and the pre-pressing tool are meant in particular.

In a further embodiment, the carrier is designed as part of the changing system in order to remove the suction tools and the pre-pressing tool from the positions in the partial-molding and pre-pressing station during the replacement and to transfer them to the tool carrier, or to pass through a reversed sequence during the insertion of new tools. As the carrier carries the suction tools itself and is driven in the second position to the pre-pressing tool, the carrier is particularly suitable for carrying out the tool change.

For this purpose, the carrier comprises, for example between the first and the second side, at least one end face which is equipped with a receiving and release means for removing the pre-pressing tool from the pre-pressing station and for holding it during the transport of the pre-pressing tool to the tool carrier. The arrangement of the means for tool change is advantageous just on the end face, as this is not used for the actual molding process and the receiving and release means can be arranged there without disrupting the molding process. Possible release means could be mechanisms, for example, which lock after a first pressure and release after a further pressure. For this purpose, the release means could be one or more pins which protrude from the end face of the carrier. Receiving means could be indentations, for example, in which one or more pins of the pre-pressing tool engage to hold it. Likewise, locking and release devices according to a linear movement in one direction would also be possible for example. A person skilled in the art is able to choose suitable mechanisms.

In a further embodiment, the transport device is designed to rotate the carrier between the first and the second position for a removal of the pre-pressing tool from the pre-molding station such that its end face faces the pre-pressing tool, and then bring the receiving and release means of the carrier into contact with corresponding counterparts of the pre-pressing tool, with the result that the pre-pressing tool is released from its holder in the pre-pressing station. Once the receiving and release means of the carrier have been chosen, the counterparts of the pre-pressing tool are correspondingly complementary mechanisms.

In a further embodiment, the transport device is designed to deposit the removed pre-pressing tool in the tool carrier by continuing the rotation of the carrier, possibly the carrier comprises a pre-pressing tool releasing mechanism for the held pre-pressing tool, in order that the pre-pressing tool is freed for receipt by the tool carrier.

In a further embodiment, the carrier is designed, after positioning of one of the suction tools via the tool carrier, to free this by means of a suction tool releasing mechanism for the held suction tool for receipt by the tool carrier, and to position the other of the suction tools above the already received suction tool by rotating the carrier, and likewise to free this by the suction tool releasing mechanism for the held suction tool for receipt by the tool carrier.

In a further embodiment, the first molding station comprises at least one further reservoir having pulp and a pulp-changing system, which is designed to provide, in a process dependent manner, one or other of the reservoirs having other pulp for the partial-molding of the molded parts before the first position is reached by the carrier. As a result, the fiber molding process can be designed variable, as blanks can be produced from different material in an uninterrupted molding process because the reservoir of pulp can be exchanged for another reservoir having other pulp at a temporally favourable point without delaying the process.

In a further embodiment, the pulp-changing system comprises rails for this purpose, on which the reservoirs having pulp can be displaced, and a drive means (for example a motor) for displacing the reservoir having pulp which is actuated in a process dependent manner by the transport device. Here, the reservoirs could be designed to be self-driving. This makes an uncomplicated and quick reservoir change possible.

In a further embodiment, the transport device is provided to drive the carrier on the route between the first and the second position such that, at a first point in time, in the first position, the molded part is partial-molded in one of the suction tools out of a first of the reservoirs having pulp and the same suction tool, at least at a second point in time later than the first point in time before the pre-pressing, the molded part is further partial-molded at least out of a second of the reservoirs having other pulp. Thus, blanks with a multiple layer structure of different fibrous materials can be produced.

For all of the previously described movements or rotations of the respective components, the first molding station can comprise a corresponding controller. Alternatively this control task can also be undertaken by the controller of the fiber molding system.

The present disclosure furthermore relates to a fiber molding system for producing a molded part from fibrous material by means of a fiber molding process performed in the fiber molding system comprising at least one first molding station according to the disclosed embodiments for the partial-molding and pre-molding of the molded part and a second molding station comprising a hot-pressing station for the finish-molding of the molded part by means of hot pressing of the pre-molded molded part.

Through the combination of the partial-molding by means of pulp and suction tool and the pre-pressing in the first molding station and the hot pressing in the second molding station, a molded part is produced in a simple manner from a fibrous material, which can provide molded parts with a very wide variety of contours very flexibly depending on the design of the contour of the suction heads. Through the combination of the suction tool for the partial-molding and the pre-molding and hot-pressing stations, the molded parts can be produced very reproducibly and with high precision and quality with respect to the shape and layer thickness of the individual molded part sections. The fiber molding system according to the disclosed embodiments is capable of processing fibers of a very wide variety of types, if these can be brought into solution such that a greater clumping of the fibers in the liquid solution prior to the processing can be prevented. In particular, robust molded parts can in this way be produced easily, effectively and flexibly from environmentally degradable fibrous material with a good level of quality and with good reproducibility. Through the transport device of the first molding station with twice the suction tools, the blanks can additionally be produced reproducibly as products effectively, flexibly, with a good level of quality and with as high as possible a throughput.

After pre-pressing has been carried out with the first molding station, the pre-molded molded part is transferred to the hot-pressing station by means of the transfer unit. The hot pressing is effected at a high temperature with much higher pressure than the pre-pressing. With the hot pressing of the pre-pressed molded part, the molded part is finish-molded with further reduction of the proportion of the liquid solution in the molded part, for example to below 10% (percent by weight), possibly to approximately 7% (percent by weight), after which it is then robust and dimensionally stable. The lower and upper hot-pressing tools are possibly made of metal. The hot pressing is carried out at the hot-pressing pressure higher than the pre-pressing pressure, for example at a hot-pressing pressure of between 0.5 N/mm2 and 1.5 N/mm2, possibly between 0.8 N/mm2 and 1.2 N/mm2. The hot-pressing pressure can be applied for a pressing time of less than 20 s, at the same time possibly more than 8 s, particularly possibly between 10 s and 14 s, still more possibly of 12 s. The hot-pressing pressure is applied hydraulically to the hot-pressing station for example via a piston rod, wherein this piston rod presses, for example, on the upper hot-pressing tool, which in turn then presses on the stationary lower hot-pressing tool, with the molded part in between. The arrangement could also be implemented the other way round. In a further embodiment, the hot-pressing station is designed so as to heat the hot-pressing sides of the hot-pressing station to temperatures higher than 150° C., possibly between 180° C. and 250° C. A reduction of the liquid (or moisture) in the molded part to below 10% (percent by weight) can thus be achieved quickly and reliably.

By the hot-pressing station, a molded part finish-molded for further processing with a greatly reduced proportion of liquid solution is produced in a simple manner from a pre-molded and still slightly variable molded part by means of hot pressing. The hot-pressing station makes it possible to produce and further process the molded parts particularly reproducibly and with high precision and quality with respect to the shape and layer thickness of the individual molded part sections. In particular, finally stable molded parts can in this way be produced easily, effectively and flexibly from environmentally degradable fibrous material with a good level of quality and with good reproducibility.

In an embodiment, the hot-pressing station is thermally decoupled from other components of the second molding station, possibly an actively cooled separation is arranged between the hot-pressing station and the other components of the second molding station. This measure protects the other components from ageing effects and securely a reliable operation time of the fiber molding system.

In a further embodiment, the second molding station comprises at least two hot-pressing stations, which optionally hot press the pre-molded blanks of the first molding station in a process dependent manner, possibly with different hot-pressing parameters. This makes a further flexibility during the production of the molded parts possible.

In a further embodiment, the fiber molding system furthermore comprises a pulp preparation and resupply unit for the resupply of pulp for the reservoir. Through a constant quality of the pulp provided, the reproducibility during the production of the blanks is further improved and the product quality can be reliably set.

In a further embodiment, the fiber molding system additionally comprises a punching station for severing excess fibrous material from the finish-molded molded part. Because of the fiber molding process, some molded parts have an irregular edge, which can be evened out through the removal of unevennesses. Here, the punching station can already be integrated in the fiber molding system (inline). Alternatively, however, fiber molding systems can also be retrofitted with a punching station, which are then arranged for example outside the actual machine direction from the partial-molding to the outputting of the finish-molded molded parts (offline). In this variant, the molded parts can be channelled into the standing station for example with a robot transfer after the hot pressing, and then channelled back into the original machine direction of the original fiber molding system again.

In an embodiment, the fiber molding system comprises a control unit for controlling at least the partial-molding station, the pre-molding station and the hot-pressing station as well as other components such as for example the punching station. The control unit can be implemented as a processor, separate computer system or web-based, and is suitably connected to the components of the fiber molding system to be controlled, for example via data cables or wirelessly by means of WLAN, radio or other wireless transmission means.

In a further embodiment, the fiber molding system additionally comprises an output unit for outputting the finish-molded molded part. The output unit outputs the molded part for further transport or for further processing, for example to subsequent cutting, inscription, printing, stacking and/or packing stations, for example with the aid of a conveyor belt.

The present disclosure furthermore relates to a method for producing molded parts from fibrous material, possibly environmentally degradable fibrous material, by means of a fiber molding process in a fiber molding system according to the disclosed embodiments with a first molding station according to the disclosed embodiments and a second molding station comprising the following steps:
partial-molding of the molded part out of a reservoir having a pulp as liquid solution with the fibrous material by means of a first and/or second suction tool as partial-molding station of the first molding station;
pre-molding of the partial-molded molded part in a pre-pressing station in the first molding station;
finish-molding of the pre-molded molded part in the second molding station by means of hot pressing; and
outputting of the finish-molded molded part from the fiber molding system.

The fiber-forming system described herein thus enables an effective and flexible production process for environmentally-friendly formed parts made from natural fibers and a corresponding machine with which different products (formed parts) can be produced variably and with good quality in a reproducible manIn an embodiment of the method, the latter additionally comprises the step of severing excess fibrous material from the finish-molded molded part by a punching station arranged behind the second molding station in the machine direction.

It should be expressly mentioned that, as far as possible, “at least” expressions have been avoided for the sake of better readability. Instead, normally, an indefinite article (“one”, “two” etc.) is to be understood to mean “at least one, at least two, etc.”, unless the context reveals that “precisely” the specified number is meant there.

At this point it should also be mentioned that, within the scope of the present patent application here, the expression “in particular” is always to be understood to mean that an optional, preferred feature is introduced with this expression. Consequently, the expression is not to be understood to mean “in fact” or “namely”.

It is understood that features of the solutions described above or in the claims may also be combined where appropriate, in order to be able to implement the advantages and effects that can be achieved in the present case in a correspondingly cumulative manner.

### BRIEF DESCRIPTION OF THE FIGURES

In addition, further features, effects and advantages of the present disclosure are explained with reference to the attached drawing and the following description. Components which at least essentially correspond in terms of their function in the individual figures are identified by the same reference symbols, with the components not having to be numbered and explained in all figures.

In the figures:

FIG. 1: schematic representation of an embodiment of the first molding station according to the present disclosure in a method sequence for the fiber molding process of (a)-(h);

FIG. 2: schematic representation of a further embodiment of the first molding station according to the present disclosure in a method sequence for the automatic tool change of (a)-(m);

FIG. 3: schematic representation of a further embodiment of the first molding station according to the present disclosure with a pulp-changing system;

FIG. 4: an embodiment of the fiber molding system according to the present disclosure; and

FIG. 5: an embodiment of the method according to the present disclosure for producing molded parts from fibrous material;

### DETAILED DESCRIPTION

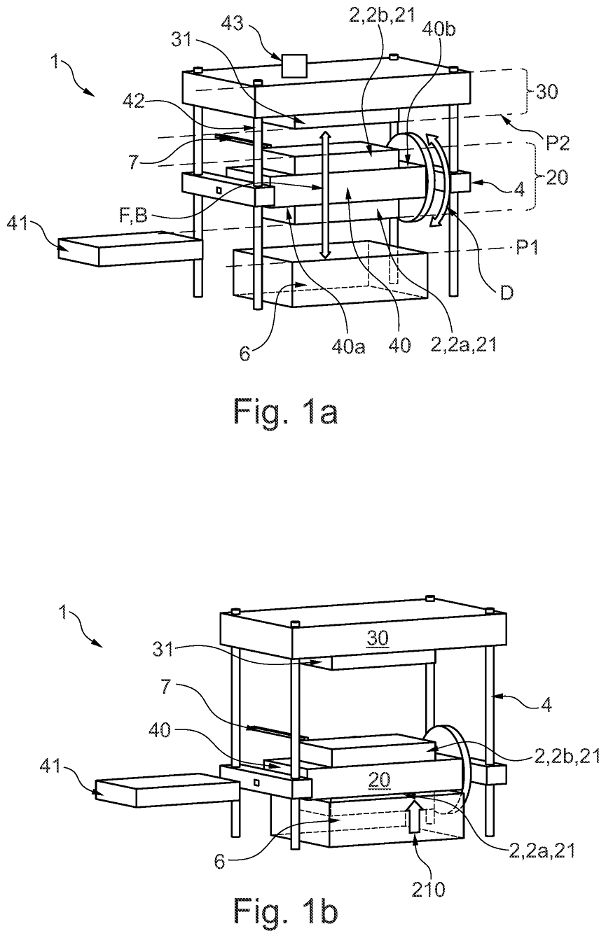

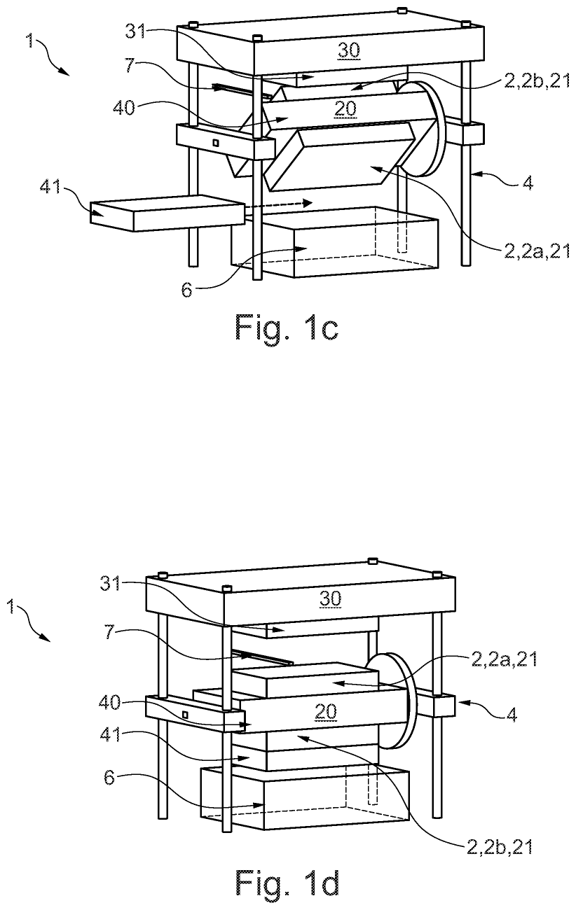

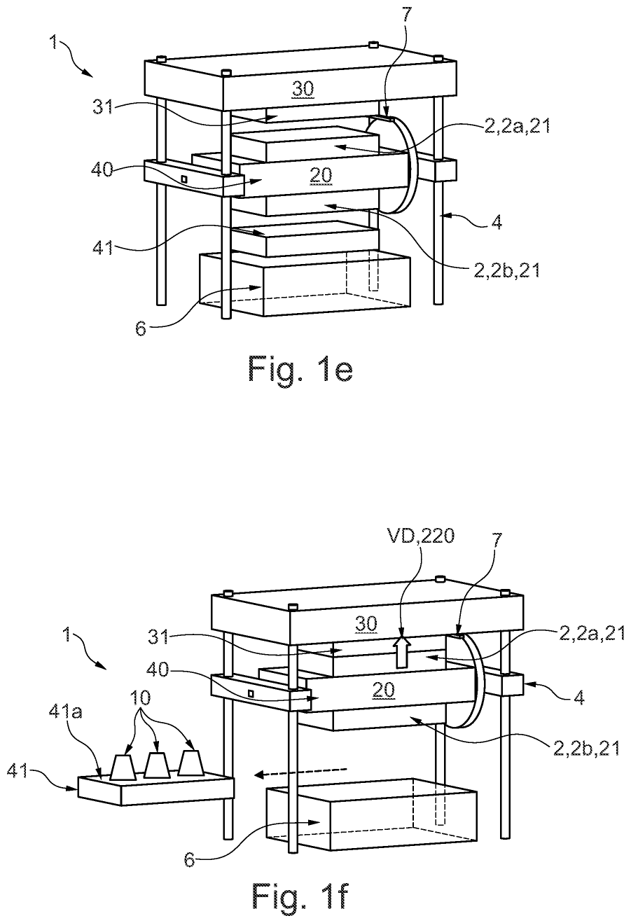

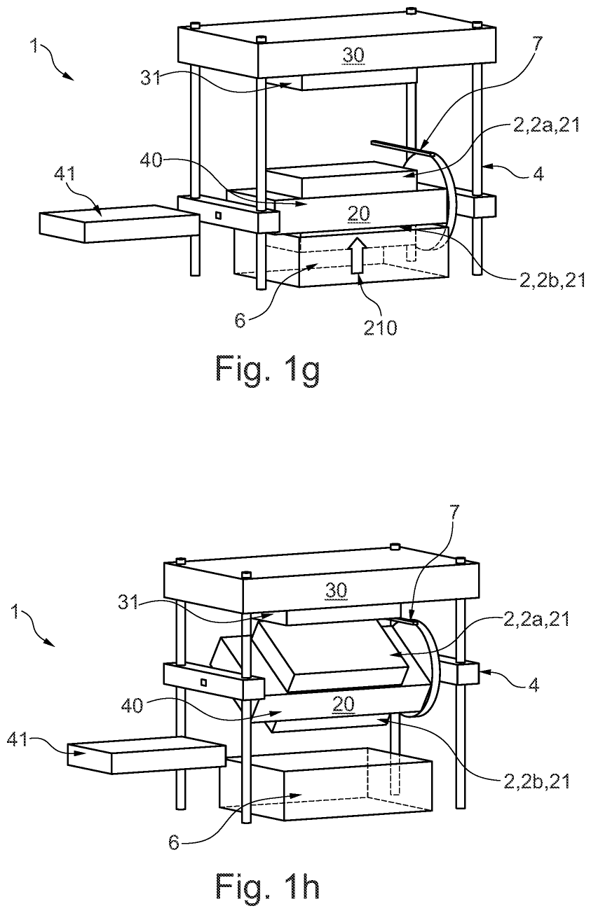

FIG. 1 shows a schematic representation of an embodiment of the first molding station 1 according to the present disclosure in a method sequence for the fiber molding process of (a)-(h). FIGS. 1a-h show the molding station 1 for the partial-molding 210 (see FIGS. 1b, 1g) and pre-molding 220 (see FIG. 10 of a molded part 10 (see FIG. 1f) out of fibrous material comprising a reservoir 6 having a pulp as liquid solution comprising the fibrous material for the molded part 10 to be partial-molded, a first and second suction tool 2, 2a, 2b as partial-molding station 20 (between the correspondingly marked lines) with in each case a plurality of suction heads 21 for drawing the fibrous material for the partial-molding 210 of the molded part 10 out of the reservoir 6 having the pulp; a pre-pressing station 30 (between the correspondingly marked lines) with a pre-pressing tool 31 with a contour that is or can be adapted to the first and second suction tool 2, 2a, 2b for the pre-molding 220 of the partial-molded molded parts 10 located in the first or second suction tools 2, 2a, 2b, wherein the molded parts 10 are pressed onto the pre-pressing tool 31 with a pre-pressing pressure VD (see FIG. 1f, in order to reduce a moisture content in the molded part 10 and to bring about a dimensional stabilization of the molded part 10, and a transport device 4 comprising a carrier 40 (here a cuboid with a certain thickness) with the first suction tool 2, 2a arranged on a first side 40a of the carrier 40 and the second suction tool 2, 2b arranged on the opposite second side 40b of the carrier 40, wherein the respective suction heads 21 are arranged on a side of the suction tools 2, 2a, 2b facing away from carrier 40 in each case, wherein by means of the transport device 4, possibly independently of each other, the carrier 40 can be rotated (see white arrow D) and moved B (white arrow F, B) along a route F at least from a first position P1 for receiving fibrous material from the reservoir 6 of pulp by means of one of the suction tools 2, 2a, 2b to a second position P2 for exerting the pre-pressing pressure VD on the molded parts 10 located in the suction tool 2, 2a, 2b. Here, the first and the second suction tool 2, 2a, 2b is connected to a gas-line system 42 via the carrier 40 such that a negative pressure generated in the gas-line system 40 by means of one or more vacuum pumps 43 is made available as suction pressure at the respective suction heads 21 for drawing in the fibrous material. The location of the vacuum pump 43 can also be chosen differently. The gas-line system 42 is here arranged in the vertical travel rails of the transport device 4. The carrier 40 is moved B vertically along the rails and can independently thereof be rotated D between the first and the second position P1, P2.

In FIG. 1a the second suction tool 2b comprises pre-pressed blanks 10. In FIG. 1b, after pre-pressing 220 has been carried out, the carrier 40 is driven into the first position P1 without rotation D of the carrier 40, that now molded parts 10 are partial-molded out of the reservoir 6 having pulp in the first suction tool 2a facing away from the pre-pressing tool 31. In FIG. 1c, after partial-molding 210 has been carried out, the carrier 40 is driven to a suitable position between the first and the second position P1, P2 and rotated D, in order to transfer the pre-pressed blanks 10 of the second suction tool 2b in FIG. 1d to the transfer unit 41 of the transport device 4, in order to remove them from the route F of the carrier 40 for forwarding to subsequent processes (see FIGS. 1e, 1f). Here, the pre-pressed blanks 10 can be ejected from the suction tool 2b by means of a pressure surge and thus transferred to the transfer unit 41. In the meantime a spraying unit 7 sprays the first suction tool 2a having the partial-molded blanks 10 with a liquid before the pre-pressing 220 during the route F of the carrier 40 to the second position P2. Here, the spraying unit 7 is controlled in a lateral movement over the surface of the first suction tool 2a. Only the respective end positions of this movement for the spraying unit 7 are shown in FIGS. 1d and 1e. Thereafter the renewed movement B of the carrier 40 to the first position, where the blanks are now partial-molded 210 in the second suction tool 2b, is effected, see FIG. 1g. After the rotation D shown in FIG. 1h the steps as already described previously are effected for the same purpose.

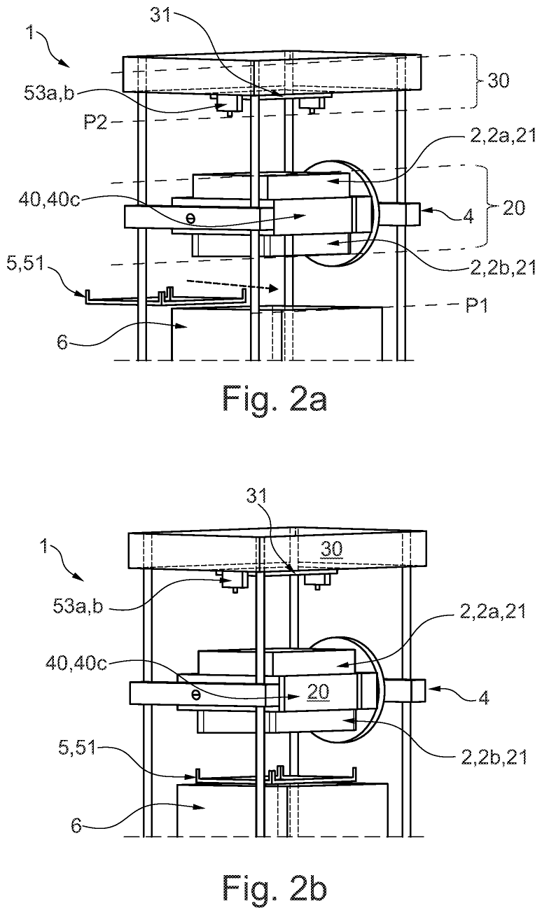

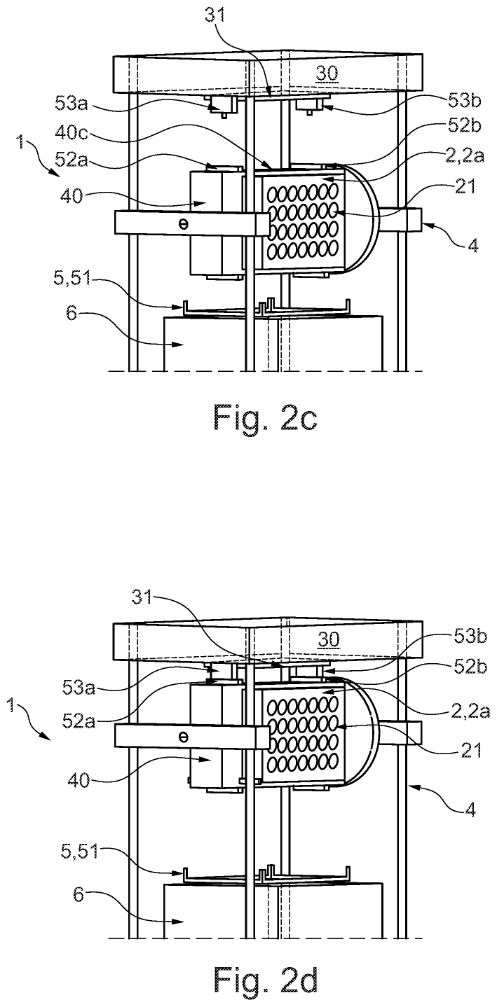

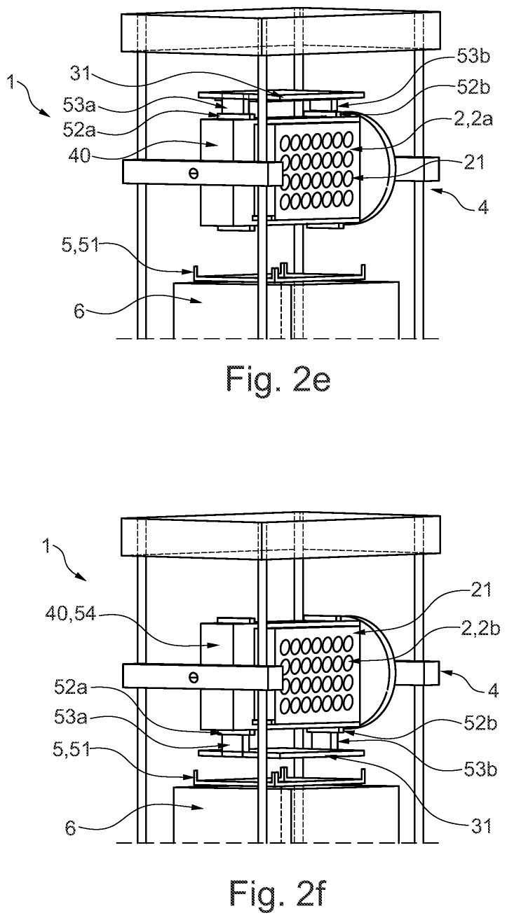

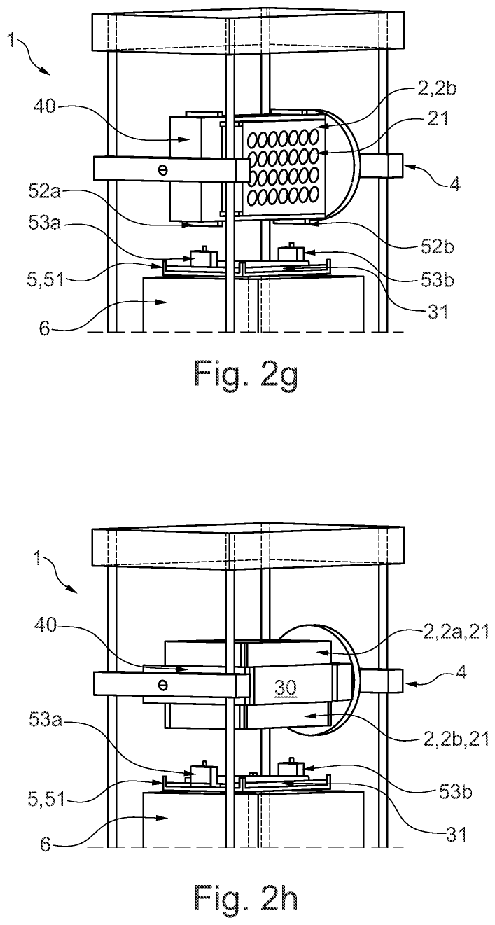

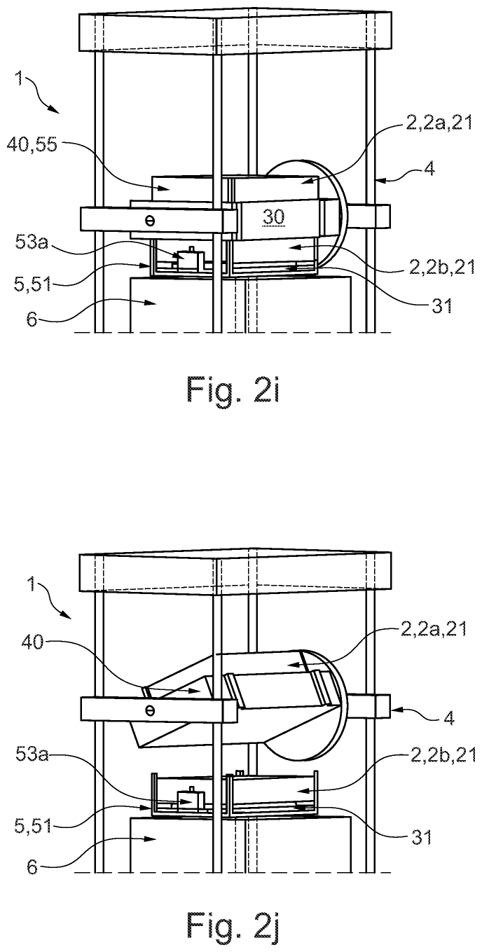

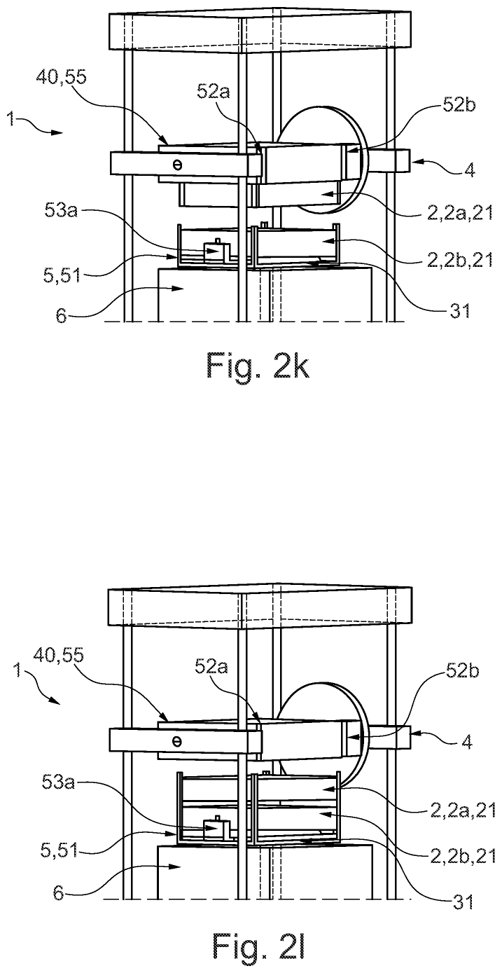

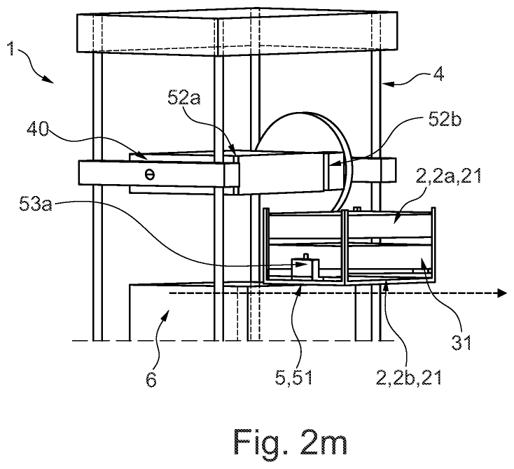

FIG. 2 shows a schematic representation of a further embodiment of the first molding station 1 according to the present disclosure in a method sequence for the automatic tool change of (a)-(m). The first molding station 1 comprises here a changing system 5 for the automatic replacement of the suction tools 2a, 2b and the pre-pressing tool 31, wherein a tool carrier 51 movable out of the first molding station 1 is provided in the changing system 5 for transporting the replaced tools 2a, 2b, 31 away from the first molding station 1 and the tool carrier 51 can pass through a reversed sequence for the insertion of new tools 2a, 2b, 31. Here, the carrier 40 is designed as part of the changing system 5 in order to remove the suction tools 2a, 2b and the pre-pressing tool 31 from the positions in the partial-molding and pre-pressing station 20, 30 during the replacement and to transfer them to the tool carrier 51, or to pass through a reversed sequence during the insertion of new tools 2a, 2b, 31. For this purpose, the carrier 40 comprises, between the first and the second side 40a, 40b, an end face 40c which is equipped with a receiving and release means 52a, 52b for removing the pre-pressing tool 31 from the pre-pressing station 30 and for holding it during the transport of the pre-pressing tool 31 to the tool carrier 51.

In FIGS. 2a, 2b the tool carrier 51 travels into its position underneath the carrier in order to receive the tools 2a, 2b and 31. For this purpose, the carrier 40 is rotated between the first and the second position P1, P2 such that its end face 40c faces the pre-pressing tool 31 (FIG. 2c). Thereafter, the carrier 40 travels in the direction of the second position P2 and brings its receiving and release means 52a, 52b into contact with corresponding counterparts 53a, 53b of the pre-pressing tool 31, with the result that the pre-pressing tool 31 is released from its holder in the pre-pressing station 30 (FIGS. 2d, 2e). Thereafter, the carrier 40 rotates by half a rotation in the direction of the tool carrier 51 (FIG. 2f), in order to deposit the removed pre-pressing tool 31 in the tool carrier 51 (FIG. 2g). Here, the carrier 40 comprises a pre-pressing tool releasing mechanism 54 for the held pre-pressing tool 31, in order that the pre-pressing tool 31 is freed for receipt by the tool carrier 51. With a further rotation, the second suction tools 2b is positioned over the tool carrier 51 and to free by means of a suction tool releasing mechanism 55 for receipt by the tool carrier 51 (FIGS. 2h, 2i). Through a further rotation D of the carrier 40, the first suction tools 2a will now position above the already received suction tool 2b and likewise to free this by the suction tool releasing mechanism 55 for receipt by the tool carrier 51 (FIGS. 2j-2l). The tool carrier 51 with the tools 2a, 2b and 31 is then moved out of the first molding station 1 for the replacement of the tools 2a, 2b, 31, see arrow (FIG. 2m).

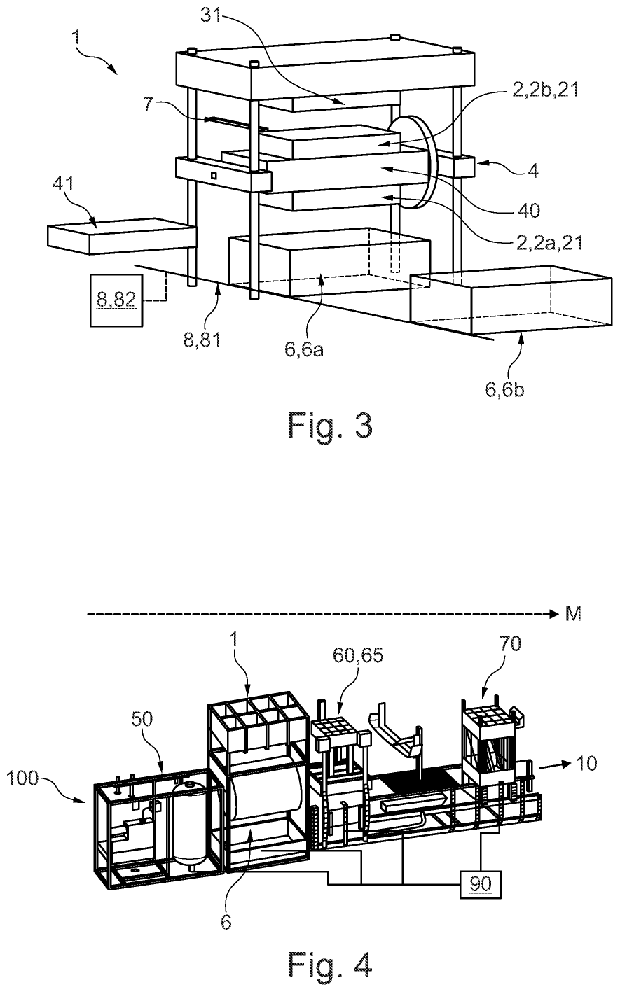

FIG. 3 shows a schematic representation of a further embodiment of the first molding station 1 according to the present disclosure with a pulp-changing system 8, wherein the first molding station 1 comprises at least one further reservoir 6, 6b having pulp, wherein the pulp-changing system 8 is designed to provide, in a process dependent manner, one or other of the reservoirs 6, 6a, 6b having other pulp for the partial-molding of the molded parts 10 before the first position P1 is reached by the carrier 40. In this embodiment, the pulp-changing system 8 comprises rails 81 for this purpose, on which the reservoirs 6, 6a, 6b having pulp can be displaced, and a drive means 82 for displacing the reservoirs 6, 6a, 6b having pulp, which is actuated by the transport device 4 or the first molding station 1 or the fiber molding system 100 in a process dependent manner. The transport device 4 or the controller of the first molding station or of the fiber molding system are provided to drive the carrier 40 on the route F between the first and the second position P1, P2 such that, at a first point in time, in the first position P1, the molded part 10 is partial-molded in one of the suction tools 2a out of a first of the reservoirs 6, 6a having pulp and the same suction tool 2a, at least at a second point in time later than the first point in time before the pre-pressing 220, the molded part 10 is further partial-molded at least out of a second of the reservoirs 6, 6b having other pulp. The same is also possible with the suction tool 2b.

FIG. 4 shows an embodiment of the fiber molding system 100 according to the present disclosure for producing a molded part 10 from fibrous material by means of a fiber molding process performed in the fiber molding system 100 comprising a first molding station 1 according to the disclosed embodiments for the partial-molding and pre-molding of the molded part 10 and a second molding station 60 comprising a hot-pressing station 65 for the finish-molding of the molded parts 10 by means of hot pressing of the pre-molded molded parts 10. The fiber molding system 100 furthermore comprises a pulp preparation and resupply unit 50 for the resupply of pulp for the reservoir 6, which is visible here on the base of the first molding station 1. Here, the hot-pressing station 65 can be thermally decoupled from other components of the second molding station 60, possibly an actively cooled separation is arranged between the hot-pressing station 65 and the other components of the second molding station 60. The second molding station 60 can moreover comprise at least two hot-pressing stations 65 (not shown in detail here), which optionally hot press the pre-molded blanks 10 of the first molding station 1 in a process dependent manner, possibly with different hot-pressing parameters. The fiber molding system 100 here additionally comprises a punching station 70 for severing excess fibrous material from the finish-molded molded part 10, which is arranged following (behind) the second molding station 60 in the machine direction M in the process. Furthermore, the fiber molding system 100 comprises a controller 90.

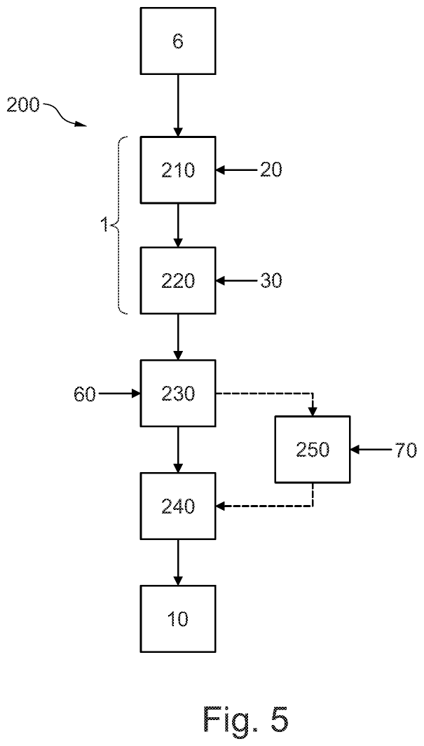

FIG. 5 shows an embodiment of the method 200 according to the present disclosure for producing molded parts 10 from fibrous material by means of a fiber molding process in a fiber molding system 100 according to the present disclosure with a first molding station 1 according to the present disclosure and a second molding station comprising the following steps of the partial-molding 210 of the molded part 10 out of a reservoir 6 having a pulp as liquid solution with the fibrous material by means of a first and/or second suction tool 2, 2a, 2b as partial-molding station 20 of the first molding station 1; of the pre-molding 220 of the partial-molded molded part 10 in a pre-pressing station 30 in the first molding station 1; of the finish-molding 230 of the pre-molded molded part 10 in the second molding station 60 by means of hot pressing; and finally of the outputting 240 of the finish-molded molded part 10 from the fiber molding system 100. Here, within the fiber molding system, a severing 250 of excess fibrous material from the finish-molded molded part 10 by a punching station 70 arranged behind the second molding station 60 in the machine direction can be effected.

At this point it should be explicitly mentioned that features of the solutions described above or in the claims and/or figures may also be combined where appropriate, in order also to be able to implement or achieve explained features, effects and advantages in a correspondingly cumulative manner.

It is to be understood that the embodiment example explained above is merely a first design of the disclosed embodiments. In this respect, the design of the disclosed embodiments is not limited to this embodiment example.

The following numbered clauses set out various non-limiting embodiments disclosed herein:

### Set A

A1. A first molding station (1) for a fiber molding system (100) for the partial-molding (210) and pre-molding (220) of a molded part (10) out of fibrous material, possibly environmentally degradable fibrous material, in a fiber molding process comprising:
a reservoir (6) having a pulp as liquid solution comprising the fibrous material for the molded part (10) to be partial-molded;
a first and second suction tool (2, 2a, 2b) as partial-molding station (20) with, in each case, a plurality of suction heads (21) for drawing the fibrous material for the partial-molding (210) of the molded part (10) out of the reservoir (6) having the pulp;
a pre-pressing station (30) with a pre-pressing tool (31) having a contour that is or can be adapted to the first and second suction tool (2, 2a, 2b) for pre-molding (220) the partial-molded molded parts (10) located in the first or second suction tools (2, 2a, 2b), wherein the molded parts (10) are pressed onto the pre-pressing tool (31) with a pre-pressing pressure (VD) in order to reduce a moisture content in the molded part (10) and to bring about a shape stabilization of the molded part (10); and
a transport device (4) comprising a carrier (40) with the first suction tool (2, 2a) arranged on a first side (40a) of the carrier (40) and the second suction tool (2, 2b) arranged on the opposite, second side (40b) of the carrier (40), wherein the respective suction heads (21) are arranged on a side of the suction tools (2, 2a, 2b) facing away from the carrier (40) in each case, wherein by means of the transport device (4), possibly independently of each other, the carrier (40) can be rotated (D) and moved (B) along a route (F) at least from a first position (P1) for receiving fibrous material from the reservoir (6) of pulp by means of one of the suction tools (2, 2a, 2b) to a second position (P2) for exerting the pre-pressing pressure (VD) on the molded parts (10) located in the suction tool (2, 2a, 2b).
   A2. The first molding station (1) according to any previous clause within set A, wherein the transport device (4) is provided to drive the carrier (40) into the first position (P1) after pre-pressing (220) with one of the suction tools (2, 2a, 2b) has been carried out in the second position (P2), without rotation (D) of the carrier (40), that now molded parts (10) can be partial-molded out of the reservoir (6) having pulp in the suction tool (2, 2a, 2b) facing away from the pre-pressing tool (31) during the pre-pressing (220) that has been carried out.
   A3. The first molding station (1) according to any previous clause within set A, wherein the transport device (4) is provided to rotate (D) the carrier (40), after pre-pressing (220) of the molded parts (10) with one of the suction tools (2, 2a, 2b) has been carried out and after partial-molding (210) of the molded parts (10) in the other of the suction tools (2, 2a, 2b) has been carried out, to a suitable position between the first and the second position (P1, P2) and to transfer the pre-pressed molded parts (10) to a transfer unit (41) of the transfer device (4), in order to remove them from the route (F) of the carrier (40) for forwarding to subsequent processes.
   A4. The first molding station (1) according to any previous clause within set A, wherein the transport device (4) is provided to eject the pre-pressed blanks (10) from the suction tool (2, 2a, 2b) by means of a pressure surge and thus to transfer them to the transfer unit (41).
   A5. The first molding station (1) according to any previous clause within set A, wherein the transfer unit (41) comprises a plurality contour adapted to the shape and number of blanks (10) on the side (41a) facing the suction tool (2, 2a, 2b) for the transfer of the blanks (10) to this contour.
   A6. The first molding station (1) according to any previous clause within set A, wherein the first molding station (1) furthermore comprises a spraying unit (7), which is provided at least to spray the suction tool (2, 2a, 2b) having the partial-molded blanks (10) with a liquid before the pre-pressing (220) during the route (F) of the carrier (40) to the second position (P2).
   A7. The first molding station (1) according to any previous clause within set A, wherein the spraying unit (7) is furthermore designed and provided to provide the blanks (10) with a functional coating after the pre-pressing (220) on the route (F) of the carrier (40) in the direction of the first position (P1), possibly likewise by means of spraying.
   A8. The first molding station (1) according to any previous clause within set A, wherein the first and the second suction tool (2, 2a, 2b) is connected to a gas-line system (42) via the carrier (40) such that a negative pressure generated in the gas-line system (40) by means of one or more vacuum pumps (43) is made available as suction pressure at the respective suction heads (21) for drawing in the fibrous material.
   A9. The first molding station (1) according to any previous clause within set A, wherein the transport device (4) is provided by a robot arm, freely movable in space, with installed carrier (40).
   A10. The first molding station (1) according to any previous clause within set A, wherein the contour of the pre-pressing tool (31) adapted to the first and second suction tool (2, 2a, 2b) is manufactured at least in part from an elastomer, possibly silicone, or in that the pre-pressing tool (31) comprises a flexible membrane for covering the blanks (10) and the pre-pressing pressure (VD) is applied as a gas pressure to the membrane, which is then pressed onto the outer contour of the blanks (10).
   A11. The first molding station (1) according to any previous clause within set A, wherein the first molding station (1) comprises a changing system (5) for the automatic replacement of the suction tools (2, 2a, 2b) and the pre-pressing tool (31), wherein a tool carrier (51) movable out of the first molding station (1) is provided in the changing system (5) for transporting the replaced tools (2, 2a, 2b, 31) away from the first molding station (1) and the tool carrier (51) can pass through a reversed sequence for the insertion of new tools (2, 2a, 2b, 31).
   A12. The first molding station (1) according to any previous clause within set A, wherein the carrier (40) is designed as part of the changing system (5) to remove the suction tools (2, 2a, 2b) and the pre-pressing tool (31) during the replacement from the positions in the partial-molding and pre-pressing station (20, 30) and to transfer them to the tool carrier (51), or to pass through a reversed sequence during the insertion of new tools (2, 2a, 2b, 31).
   A13. The first molding station (1) according to any previous clause within set A, wherein the carrier (40) comprises, between the first and the second side (40a, 40b), at least one end face (40c) which is equipped with a receiving and release means (52a, 52b) for removing the pre-pressing tool (31) from the pre-pressing station (30) and for holding it during the transport of the pre-pressing tool (31) to the tool carrier (51).
   A14. The first molding station (1) according to any previous clause within set A, wherein the transport device (4) is designed to rotate the carrier (40) between the first and the second position (P1, P2) for a removal of the pre-pressing tool (31) from the pre-molding station (30) such that its end face (40c) faces the pre-pressing tool (31), and then bring the receiving and release means (52a, 52b) of the carrier (40) into contact with corresponding counterparts (53a, 53b) of the pre-pressing tool (31), with the result that the pre-pressing tool (31) is released from its holder in the pre-pressing station (30).
   A15. The first molding station (1) according to any previous clause within set A, wherein the transport device (4) is furthermore designed to deposit the removed pre-pressing tool (31) in the tool carrier (51) by continuing the rotation (D) of the carrier (40), possibly the carrier (40) comprises a pre-pressing tool releasing mechanism (54) for the held pre-pressing tool (31), in order that the pre-pressing tool (31) is freed for receipt by the tool carrier (51).
   A16. The first molding station (1) according to any previous clause within set A, wherein the carrier (40) is furthermore designed, after positioning of one of the suction tools (2, 2a, 2b) via the tool carrier (51), to free this by means of a suction tool releasing mechanism (55) for the held suction tool (2, 2a, 2b) for receipt by the tool carrier (51), and to position the other of the suction tools (2, 2a, 2b) above the already received suction tool (2, 2a, 2b) by rotating (D) the carrier (40), and likewise to free this by the suction tool releasing mechanism (55) for the held suction tool (2, 2a, 2b) for receipt by the tool carrier (51).

A17. The first molding station (1) according to any previous clause within set A, wherein the first molding station (1) comprises at least one further reservoir (6, 6b) having pulp and a pulp-changing system (8), which is designed to provide, in a process dependent manner, one or other of the reservoirs (6, 6a, 6b) having other pulp for the partial-molding of the molded parts (10) before the first position (P1) is reached by the carrier (40).

A18. The first molding station (1) according to any previous clause within set A, wherein the pulp-changing system (8) comprises rails (81) for this purpose, on which the reservoirs (6, 6a, 6b) having pulp can be displaced, and a drive means (82) for displacing the reservoirs (6, 6a, 6b) having pulp, which is actuated in a process dependent manner by the transport device (4).
A19. The first molding station (1) according to any previous clause within set A, wherein the transport device (4) is provided to drive the carrier (40) on the route (F) between the first and the second position (P1, P2) such that, at a first point in time, in the first position (P1), the molded part (10) is partial-molded in one of the suction tools (2, 2a, 2b) out of a first of the reservoirs (6, 6a) having pulp and the same suction tool (2, 2a, 2b), at least at a second point in time later than the first point in time before the pre-pressing (220), the molded part (10) is further partial-molded at least out of a second of the reservoirs (6, 6b) having other pulp.

### Set B

B1. A fiber molding system (100) for producing a molded part (10) from fibrous material by means of a fiber molding process performed in the fiber molding system (100) comprising at least one first molding station (1) according to any previous clause within set A for the partial-molding and pre-molding of the molded part (10) and a second molding station (60) comprising a hot-pressing station (65) for the finish-molding of the molded part (10) by means of hot pressing of the pre-molded molded part (10).
B2. The fiber molding system (100) according to any previous clause within set B, wherein the fiber molding system (100) furthermore comprises a pulp preparation and resupply unit (50) for the resupply of pulp for the reservoir (6).
B3. The fiber molding system (100) according to any previous clause within set B, wherein the hot-pressing station (65) is thermally decoupled from other components of the second molding station (60), possibly an actively cooled separation is arranged between the hot-pressing station (65) and the other components of the second molding station (60).
B4. The fiber molding system (100) according to any previous clause within set B, wherein the second molding station (60) comprises at least two hot-pressing stations (65), which optionally hot press the pre-molded blanks (10) of the first molding station (1) in a process dependent manner, possibly with different hot-pressing parameters.
B5. The fiber molding system (100) according to any previous clause within set B, wherein the fiber molding system (100) additionally comprises a punching station (70) for severing excess fibrous material from the finish-molded molded part (10).

### Set C

C1. A method (200) for producing molded parts (10) from fibrous material, possibly environmentally degradable fibrous material, by means of a fiber molding process in a fiber molding system (100) according to any previous clause within set B with a first molding station (1) according to any previous clause within set A and a second molding station (60) comprising the following steps.
partial-molding (210) of the molded part (10) out of a reservoir (6, 6a, 6b) having a pulp as liquid solution with the fibrous material by means of a first and/or second suction tool (2, 2a, 2b) as partial-molding station (20) of the first molding station (1);
pre-molding (220) of the partial-molded molded part (10) in a pre-pressing station (30) in the first molding station (1);
finish-molding (230) of the pre-molded molded part (10) in the second molding station (60) by means of hot pressing; and
outputting (240) of the finish-molded molded part (10) from the fiber molding system (100).
   C2. The method according to any previous clause within set C, additionally comprising the step of severing (250) excess fibrous material from the finish-molded molded part (10) by a punching station (70) arranged behind the second molding station (60) in the machine direction.

At this point it should be explicitly pointed out that features of the solutions described above or in the claims and/or figures can also be combined if appropriate in order to be able to implement or achieve the features, effects and advantages explained in a cumulative manner.

It goes without saying that the exemplary embodiment explained above is merely a first embodiment of the present disclosure. In this respect, the design of the disclosed embodiments is not limited to this exemplary embodiment.

What is claimed is:

1. A molding station for a fiber molding system for the partial-molding and pre-molding of a molded part out of fibrous material, comprising:
a reservoir having a pulp as a liquid solution comprising the fibrous material for the molded part to be partial-molded;
a first and second suction tool as partial-molding station with, in each case, a plurality of suction heads for drawing the fibrous material for the partial-molding of the molded part out of the reservoir having the pulp;
a pre-pressing station with a pre-pressing tool having a contour that is or can be adapted to the first and second suction tool for pre-molding the partial-molded molded parts located in the first or second suction tools, wherein the molded parts are pressed onto the pre-pressing tool with a pre-pressing pressure in order to reduce a moisture content in the molded part and to bring about a shape stabilization of the molded part; and
a transport device comprising a carrier with the first suction tool arranged on a first side of the carrier and the second suction tool arranged on the opposite, second side of the carrier, wherein the respective suction heads are arranged on a side of the suction tools facing away from the carrier in each case, wherein by means of the transport device, possibly independently of each other, the carrier can be rotated and moved along a route at least from a first position for receiving fibrous material from the reservoir of pulp by means of one of the suction tools to a second position for exerting the pre-pressing pressure on the molded parts located in the suction tool.
